(19) United States
(12) Patent Application Publication
(10) Pub. No.: US 2006/0085277 A1
(43) Pub. Date: Apr. 20, 2006

(54) System and method for transacting sales of home furnishings in a non-retail environment

(76) Inventor: Catharine V. Arnston, Boston, MA (US)

Correspondence Address: FISH & RICHARDSON PC, P.O. BOX 1022, MINNEAPOLIS, MN, 55440-1022, US

(21) Appl. No.: 11/216,888

(22) Filed: Aug. 31, 2005

Related U.S. Application Data
(60) Provisional application No. 60/606,628, filed on Sep. 2, 2004.

(51) Int. Cl. G06Q 30/00

(52) U.S. Cl. 705/26

(57) ABSTRACT

A method and system for selecting an item of home furnishings displayed in an accommodation includes accepting from a user an identification associated with one of a plurality of accommodations. The furnishings displayed in the identified one of the plurality of accommodations are determined. Information identifying the displayed furnishings to the user is displayed. A selection of at least one of the home furnishings is selected from the user.

### CROSS-REFERENCE TO RELATED APPLICATION

This application claims priority under 35 U.S.C. §119 to U.S. Provisional Patent Application Ser. No. 60/606,628, filed on Sep. 2, 2004, and entitled “SYSTEM FOR SELLING HOME DECOR AND OTHER PRODUCTS THAT DOES NOT RELY ON TRADITIONAL RETAIL CHANNELS,” the entire contents of which are hereby incorporated by reference.

### TECHNICAL FIELD

The present invention relates generally to a system and methodology for selling home décor and other products to consumers.

### BACKGROUND

It can be appreciated that furniture and other home décor products have been sold to consumers for many years. Typically consumers have had three channels through which they could purchase furniture and decorative accessories—retailers, catalogues or designer showrooms (the latter is only available as a choice if the consumer has an interior designer working with them since consumers are not allowed to make direct purchases from designer showrooms). With the recent emergence of the internet, a fourth choice has emerged—buying furniture through internet web sites. In any case, the retail environment for home décor is fragmented into many separate channels that are disconnected, competitive and which collectively do not operate as one cohesive unit. One significant result is that sales commissions are calculated many times, for different amounts and are paid by many disparate bodies to multiple sales people at multiple points in the channel. This results in the different channel participants competing with one another for sales as well as for commissions and is an inefficient way to manage the sales channel and sales commission process.

### SUMMARY

In a general aspect of the invention, a method of selecting an item of home furnishings displayed in an accommodation includes the following steps. An identification associated with one of a plurality of accommodations is accepted from a user. The furnishings displayed in the identified one of the plurality of accommodations are determined. Information identifying the displayed furnishings to the user is displayed. A selection of at least one of the home furnishings is selected from the user.

In another general aspect, the invention relates to a computer program product residing on a computer readable medium for allowing a user to select an item of home furnishings displayed in an accommodation. The computer program comprises instructions to cause a computer to a) accept from a user an identification of one of a plurality of accommodations, b) determine the furnishings displayed in the identified one of the plurality of accommodations, c) provide display information identifying the displayed furnishings to the user; and d) accept a selection from the user of at least one of the home furnishings.

In still another general aspect, the invention relates to a system for allowing a user to select an item of furnishings displayed in one of a plurality of accommodations. The system includes a memory storing information relating to the furnishings and each of the plurality of accommodations. The system also includes a computing device, operably connected to the memory; and configured to a) accept from a user an identification of one of the plurality of accommodations; b) determine the furnishings displayed in the identified one of the plurality of accommodations; c) provide display information identifying the displayed furnishings to the user; and d) accept a selection from the user of at least one of the home furnishings. The system further includes a display for displaying information identifying the displayed furnishings to the user.

Embodiments of these aspects of the invention may include one or more of the following features.

The method, computer program product and system further includes conducting at least a part of a commercial transaction between the user and a supplier of the at least one of the home furnishings. A commission for each of a plurality of parties (e.g., the hotel partner, marketing partner, designer, and manufacturer) associated with the commercial transaction is computed. An identification of one of a plurality of rooms from the selected one of the plurality of accommodations is accepted from the user. The plurality of accommodations are owned and operated by different entities. The accommodation is a hotel.

Each of the furnishings has an associated product code including a manufacturer subcode representative of the manufacturer of the furnishing; a stock keeping (SKU) subcode; and a partner subcode associated with the accommodation where the furnishing is displayed. The product code can further include a designer subcode corresponding to the designer associated (e.g., makes or selects) with the furnishing, with the computing step further including determining a commission for the designer. The product code can also include dealer and marketing partner subcodes.

The method, computer program product and system further includes accepting the identification of one of the plurality of accommodations and accepting the selection from the user of at least one of the home furnishings is via a communications network. The communications network is the Internet. The identification is associated with one or more of a style of the accessory, a type of the accessory, a designer of the accessory, a location of the accommodation, and one of the plurality of rooms.

Displaying information identifying the displayed furnishings to the user further includes displaying the furnishing in isolation from or with other furnishings from the one of the plurality of rooms.

Among other advantages, the method, computer program product, and system described above allows consumers to experience and purchase furniture and home décor products without having to spend large amounts of time researching catalogues or without making special trips to retail stores or designer showrooms to find what they want for their home decor. Consumers can get instant and complete decorating solutions for their own home while engaging in relaxing activities in places not intended for furniture/home décor sales (e.g., hotels or restaurants) where the primary purpose of business is clearly something other than furniture sales. Consumers are able to purchase any furniture and home décor products that they see in their hotel or restaurant (or spa etc), without pressure from sales people and without uncertainty since they have already seen and experienced the furniture and decorative products first hand (such as in their hotel room) before purchasing them.

In another aspect of the invention, a method for selling a hotel accessory displayed in a hotel includes receiving a sale order from a consumer for the hotel accessory, the hotel accessory having a product code and determining a commission for a hotel partner. The product code includes a manufacturer subcode representative of the manufacturer of the hotel accessory, a stock keeping (SKU) subcode; and a hotel partner subcode associated with the hotel where the hotel accessory is displayed.

Embodiments of these aspects of the invention may include one or more of the following features. Prior to determining the commission, the cost to the manufacturer of the furniture item is deducted from the cost to the consumer. The commission amount to the hotel partner is deposited (e.g., electronically).

A wait period before moving the commission from a Hold condition to a Pay condition is established. The product code further includes a designer subcode associated with the designer that selects or makes the accessory and/or a dealer subcode associated with the dealer of the accessory. The determining step including determining a commission for the designer and/or the dealer.

Among other advantages, the invention makes use of a product code associated with sold items so that each sale is associated with the particular hotel where the product was seen, with the particular design firm that placed it there, with the particular dealer who may have sold it and with the particular vendor who manufactured it. The invention also automatically tracks and calculates these commissions through a centralized web based system that ensures that each sales partners who are part of the new sales channel automatically receive their respective sales commissions as a result of every sale.

The inventions generally relate to providing an innovative service including a new system and methodology for selling home décor and other products to consumers. The inventions do not rely on any of the traditional retail channels or methodologies. Rather, a new paradigm and new sales network has at its core, a methodology of coding each product so that a web-based, centralized, sales engine can automatically recognize each product by its product coding. The product coding automatically identifies all the channel partners involved in the product sale and determines what commission rates are to be paid to each of them. Integrated into this methodology is the ability to calculate the gross margin from each product sale, from which all commissions are then tracked, calculated and paid to the multiple channel partners involved with each product sale. The methodology provides a service to hotels (or other non-retail environments) the ability to sell to their guests, any of the furniture, decorative accessories or other products that are in the hotel and are part of their hotel brand/décor. In other applications, the methodology can also be provided as a service to restaurants and to any other commercial operation where there are decorative products in their place of business but where their primary business purpose is anything but the retailing of home décor products.

### BRIEF DESCRIPTION OF DRAWINGS

FIG. 1 illustrates the relationship between the major components of a system for transacting sales of home furnishings in a non-retail environment.

FIG. 1 (a) illustrates the main processes in the system of FIG. 1.

FIG. 2 illustrates an expanded view of the major components of the system.

FIG. 3 (a) illustrates the primary search processes on the master website for users searching for products.

FIG. 3 (b) illustrates the primary search processes using the system.

FIG. 3 (c) illustrates the main search pathways that are available to a consumer using the master website to make a purchase.

FIGS. 4 (a) through (i) illustrate sample screen shots of a hotel partner website.

FIGS. 5 (a) through (h) illustrate sample screen shots of the master website.

FIG. 6 illustrates the four main processes by which a consumer can make a purchase using the system.

FIG. 7 illustrates the process a hotel goes through to become a partner of the system.

FIG. 8 illustrates the primary components of the product codes.

FIG. 9 illustrates the product code methodology for calculating a product sale and all of the sales commissions that are owed to all partners.

### DETAILED DESCRIPTION

Turning now descriptively to the figures in which similar reference characters denote similar elements, the Figures illustrate a system and methodology by which furniture and other objects for the consumer or their home that are currently part of the décor of hotel partners, can be purchased by the consumer through a master website. A similar process exists for those purchases that are made by the consumer when they use the specific shopping site that is created for each specific hotel. The figures also illustrate technology and systems that have been designed to support this new purchasing process including a methodology for coding each product that is for sale so that the system can automatically determine the gross margin for every product sold as well as the commissions that are due to each hotel, interior designer, dealer or marketing partner as a result of these sales. All transactions from all of the hotel websites as well as the master website flow through a centralized transaction processing engine/system. The figures thus illustrate a number of the perspectives and processes that occur on and through these websites including all the links to all of the parties that are part of this search methodology and transaction processing system.

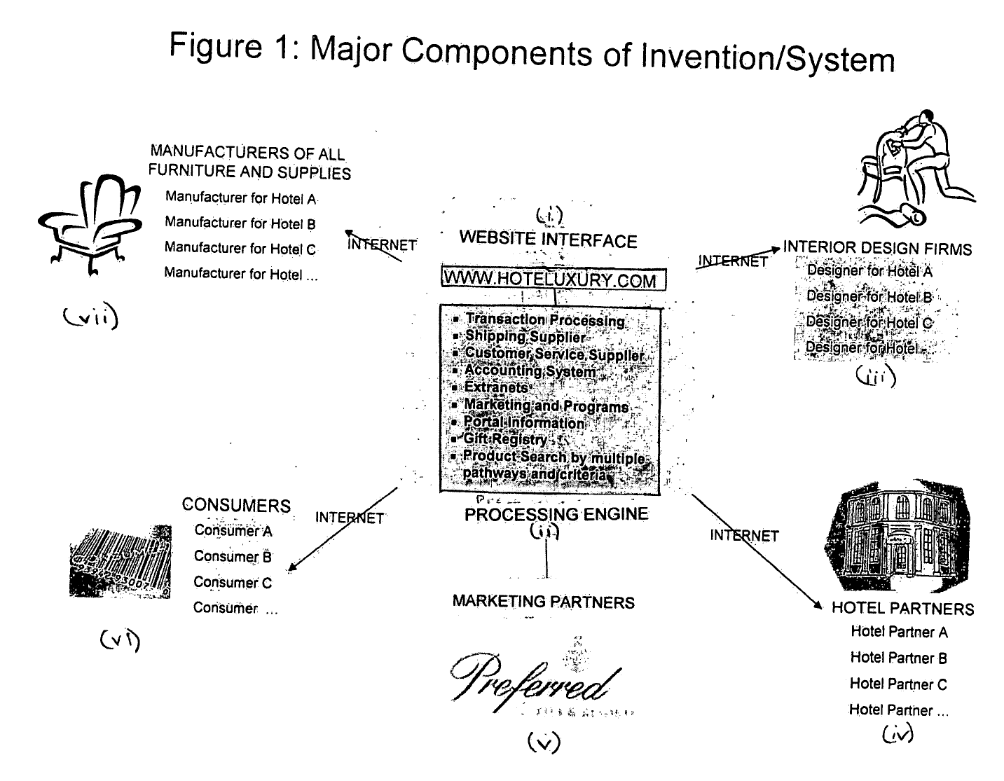

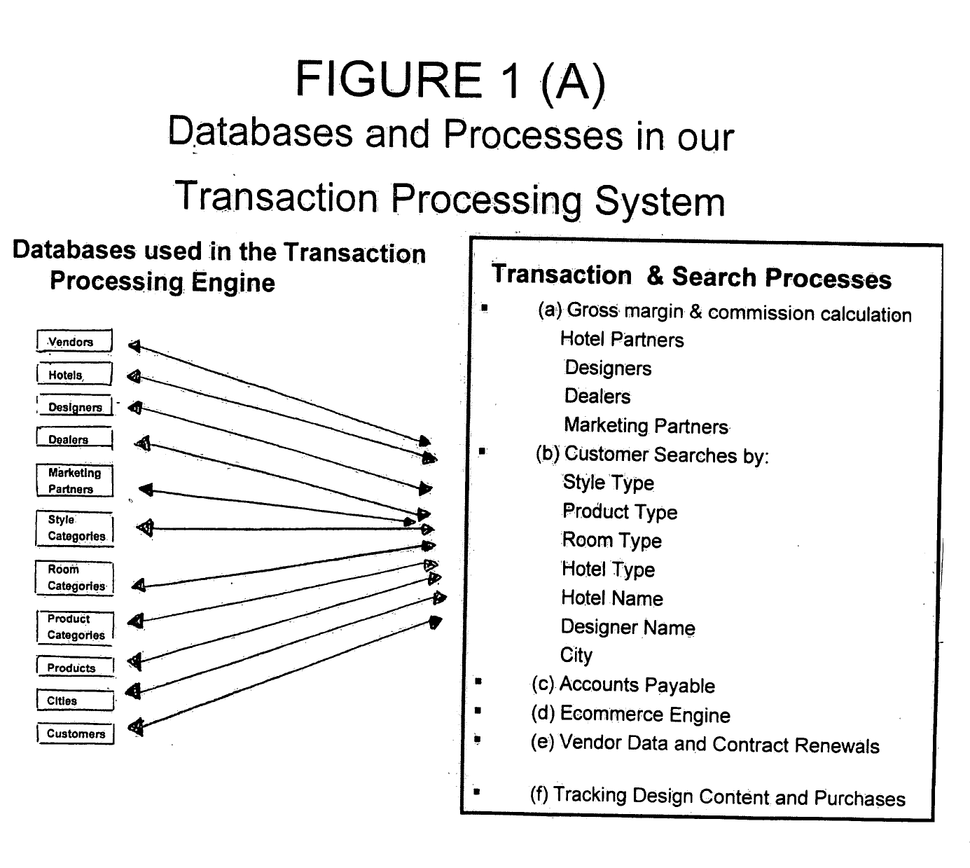

FIG. 1 illustrates the primary components of the system in which the Hoteluxury at Home website (referred to as the master website) serves as the interface and operating hub for connecting various parties and databases via a communication network (e.g. Internet). The Hoteluxury at Home website also serves as the central engine for processing and storing all transactions and for storing/accessing all databases that are part of the system's operations. The main components in this system and as illustrated in this Figure include (i) the hoteluxury.com interface (ii) the processing engine where all transactions and databases reside (iii) the interior designers (iv), the hotel partners, (v), the marketing partners (vi), consumers (vii) the manufacturers and suppliers

FIG. 1 (A) illustrates the many processes that are part of the Hoteluxury at Home website's engine/system including but not limited to: a) the identification, calculation, tracking and payment of gross margins and commissions owed to each of hotel, designer, dealer and marketing partners for each product that is sold; b) the process of website searches for products by different search pathways/criteria including search by style type, product type, room type, hotel type, hotel name, designer name, city; c) the tracking of and paying of accounts payable; d) a complete ecommerce engine for processing all sales. The system will process all orders, accept all payments, connect with all manufacturing vendors, shipping vendor and have direct links to credit card processing vendors, customer service, accounts payable and receivable, commissions allocation files, customer profile database and will also connect to extranets for vendors, hotel partners and interior design partners; e) tracking of vendor pricing and agreements and f) the ability to track all purchasing patterns and design preferences of customers and other design related content.

In addition, FIG. 1(a) illustrates how the many different databases that are used in the system interact with this transaction processing engine (manufacturers, hotels, designers, dealers, marketing partners, products, customers etc.).

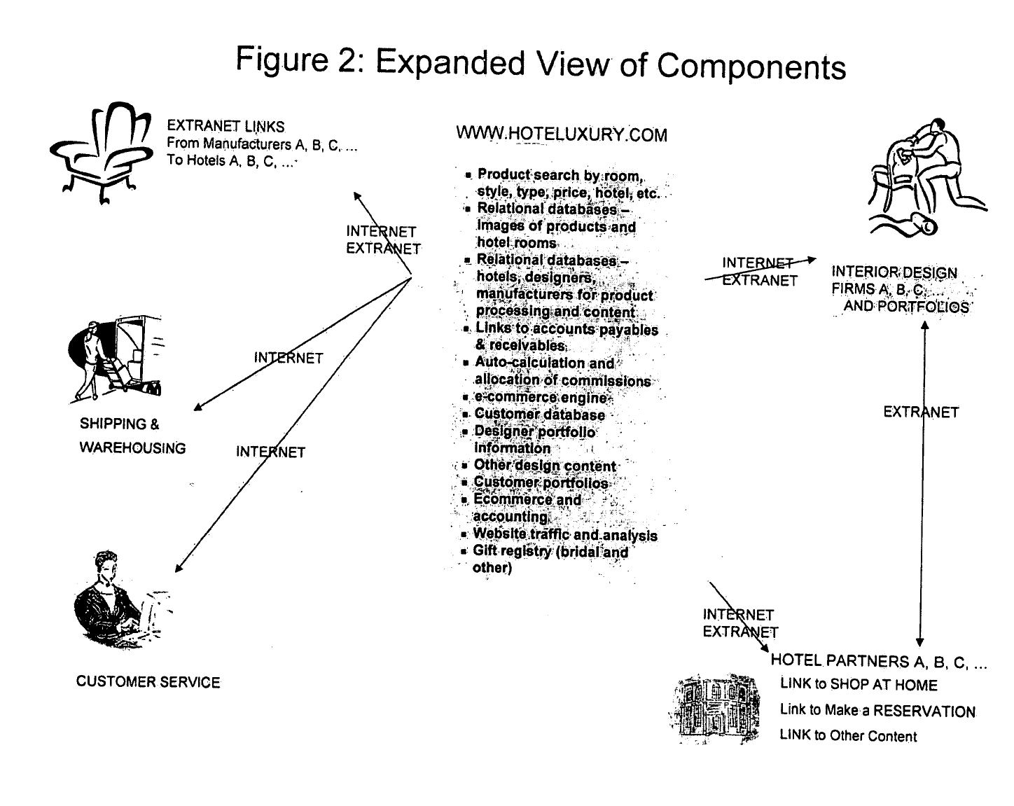

FIG. 2 illustrates the variety of databases that interact with the Hoteluxury website. These databases include but are not limited to a) the relational database of individual products for sale including their prices, their style, their product type and their photos both as individual products and in the context of the hotel rooms they are found in b) the relational database of photos of all the hotel rooms of partners hotels (or other partner establishments); c) the database of customers; d) the databases of hotel partners, e) the database of interior design firms, f) the database of dealers g) the database of all vendors; h) the database of types of home products that can be searched by design style of product, type of home décor product, price point of product; room that product tends to be used in, hotel or city that product can be seen in, and other databases, such as from marketing partners. The collection and integration of all these databases is an integral aspect of the system.

FIG. 2 further illustrates how the system provides direct links from the master website to each partner hotel's home pages and also provides direct links to their “reservations” page. This will allow users who are on the master Hoteluxury website to seamlessly make a reservation at any hotel partners whose interiors and furniture they saw on the master website. This seamless and direct connection with all hotel partners to facilitate room reservations as well as product purchases is part of the overall system.

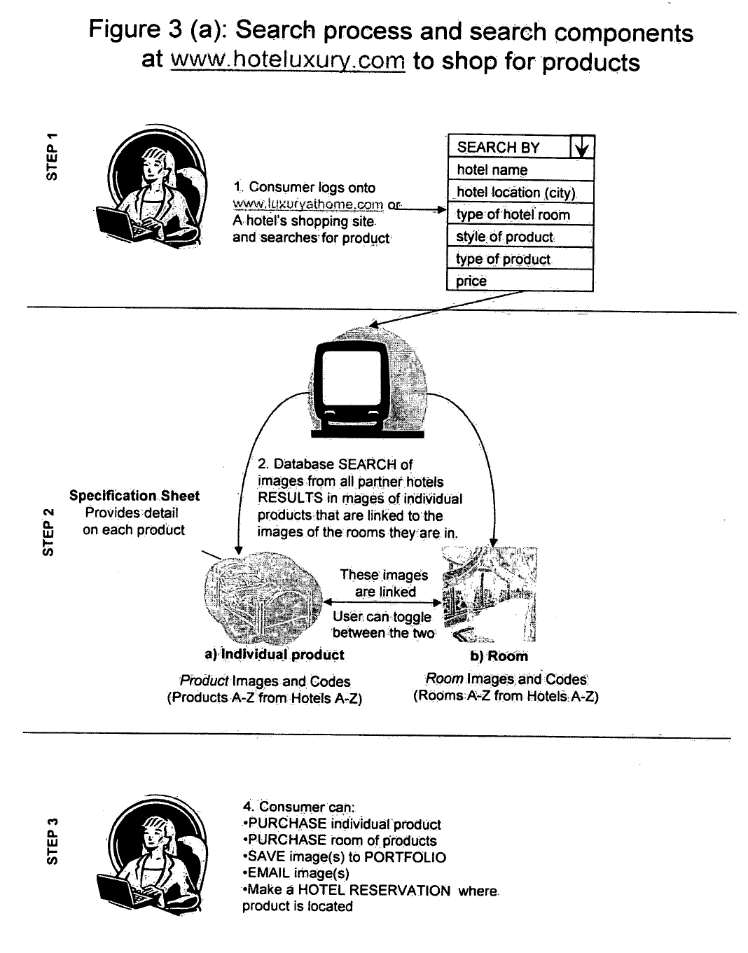

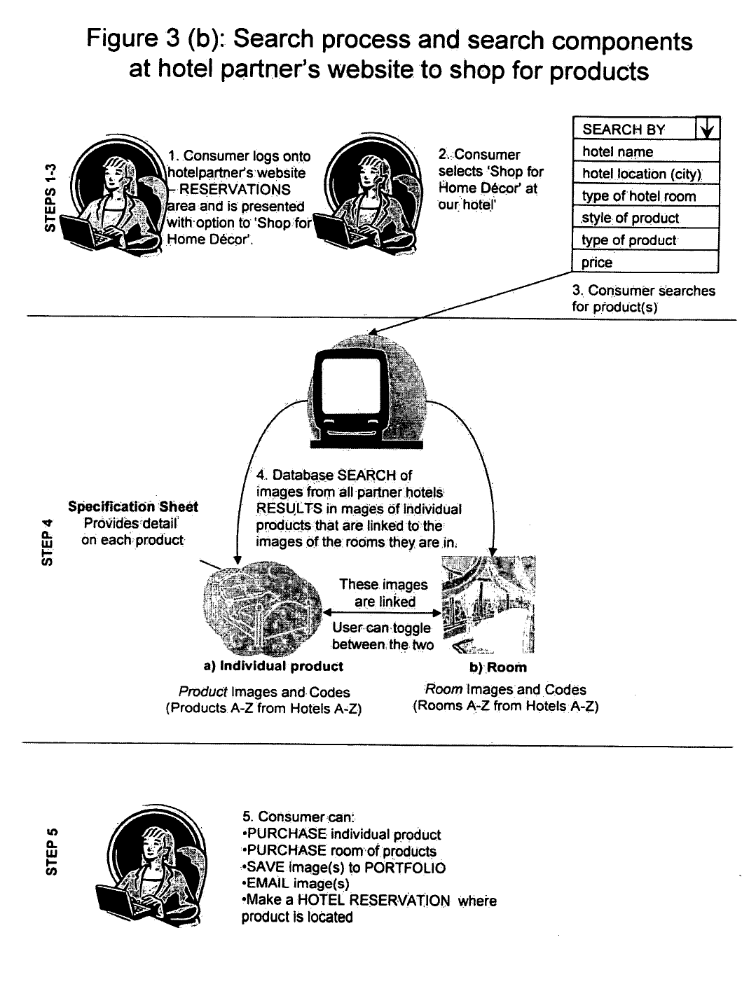

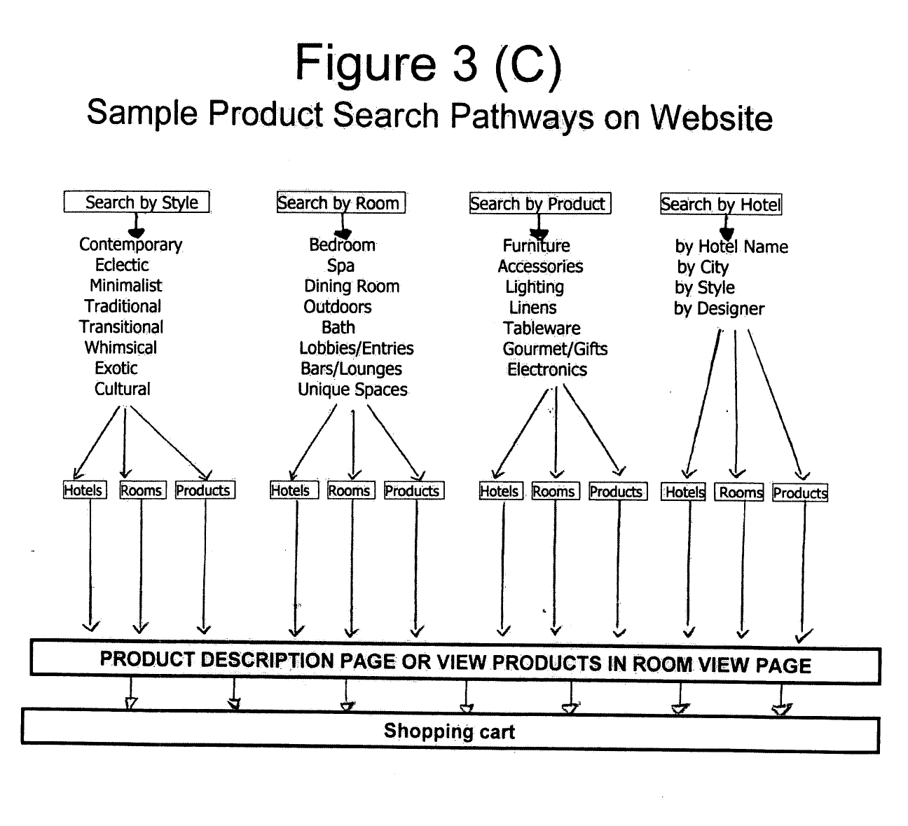

FIG. 3 (a) illustrates the basic search process that a consumer would use on the master website in order to purchase a product using this system

FIG. 3 (b) illustrates the basic search process that a consumer would use at a hotel partner's website to purchase a product using this system.

FIG. 3(c) illustrates a few of the main search pathways that are available to a consumer who is using this system in order to make a purchase

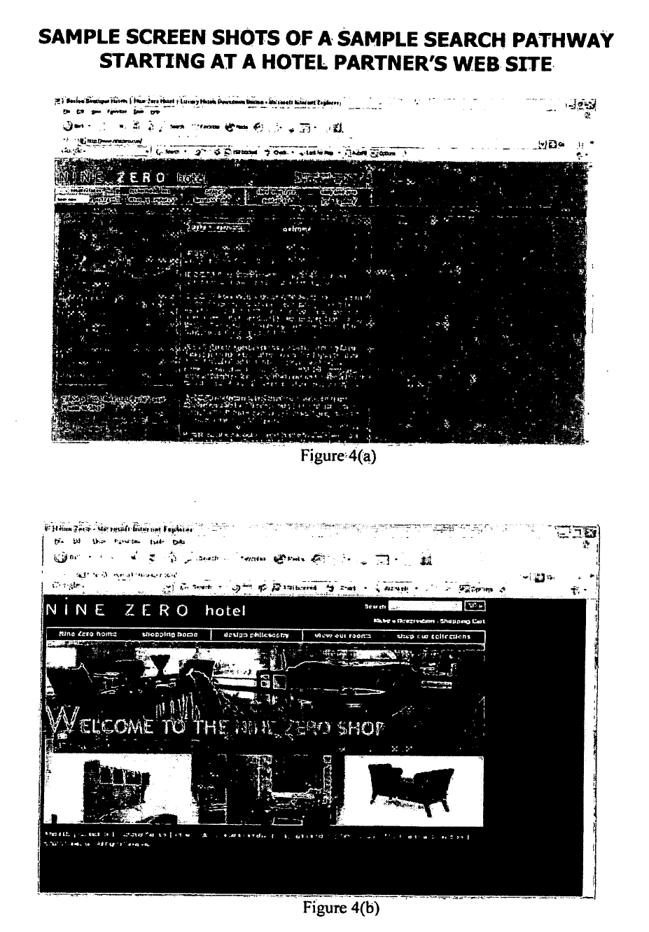

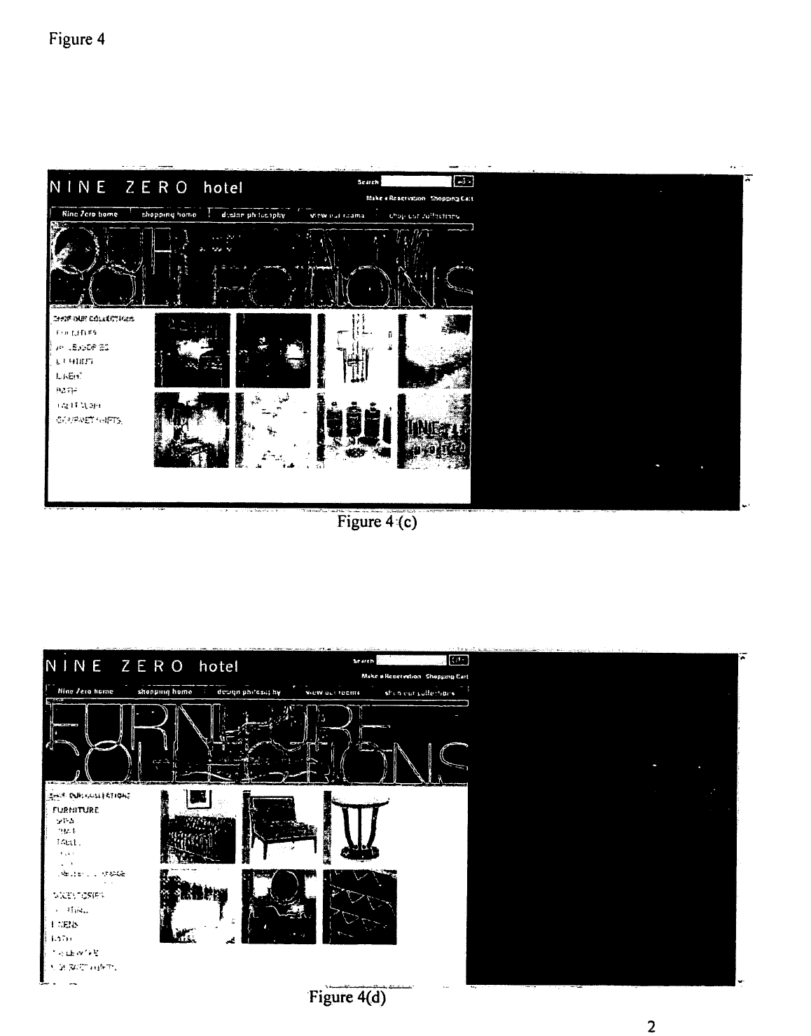

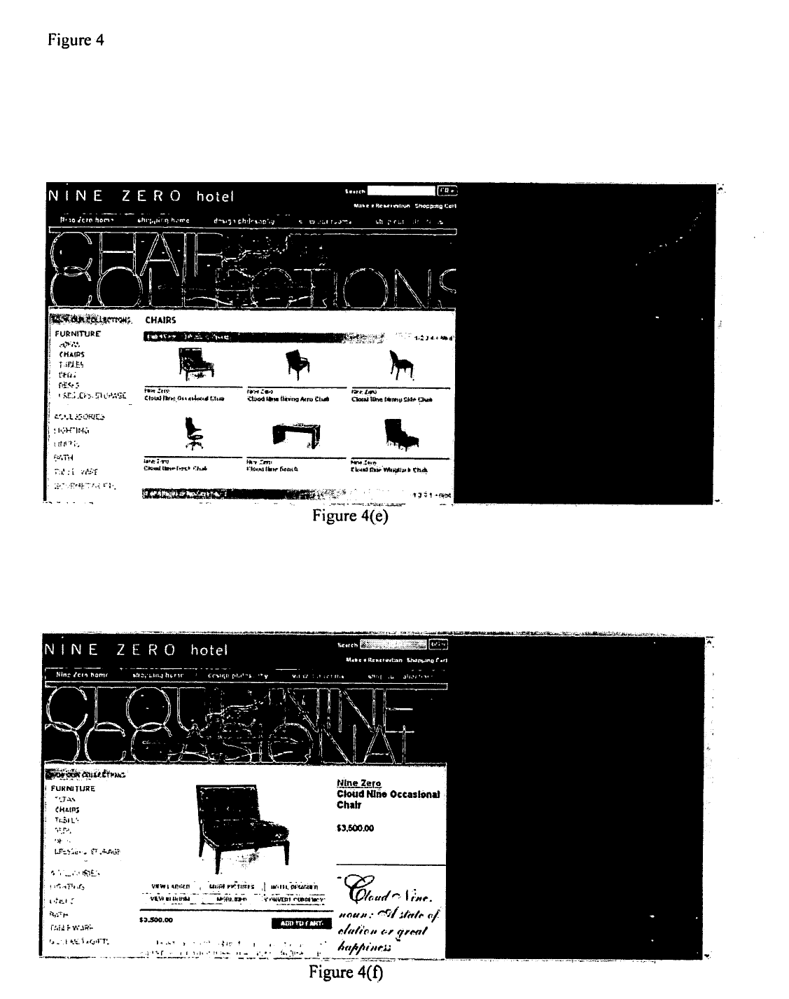

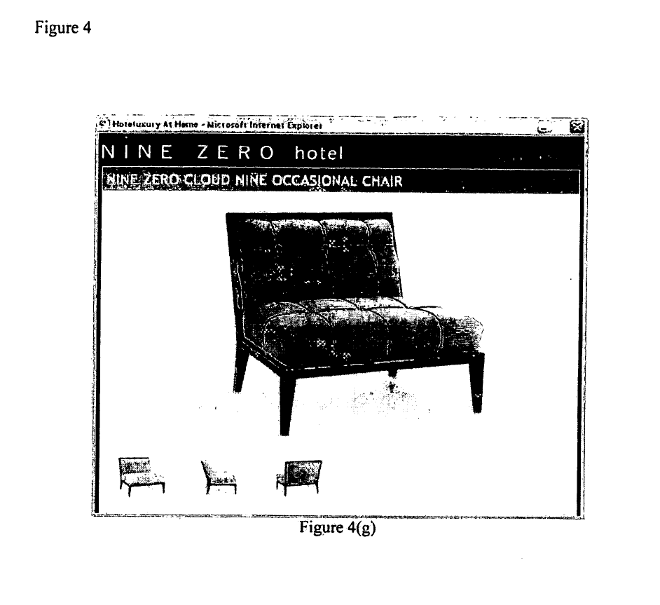

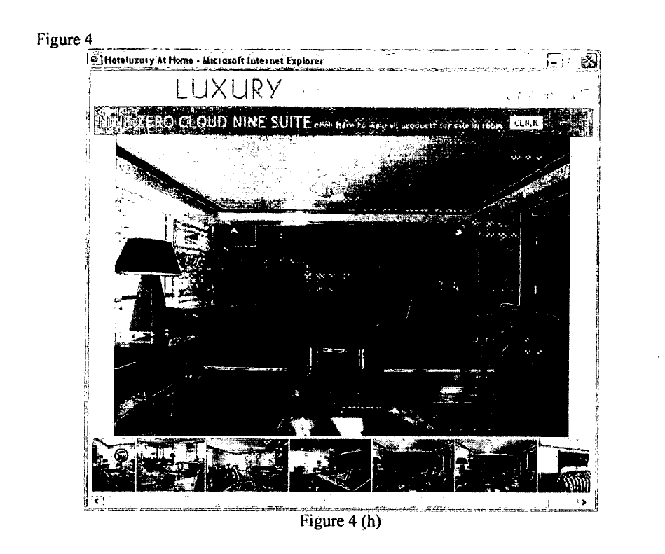

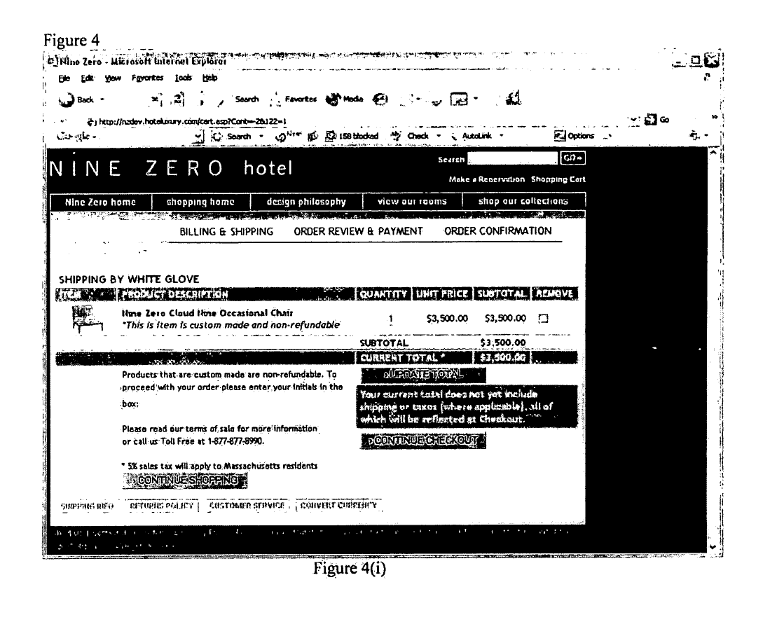

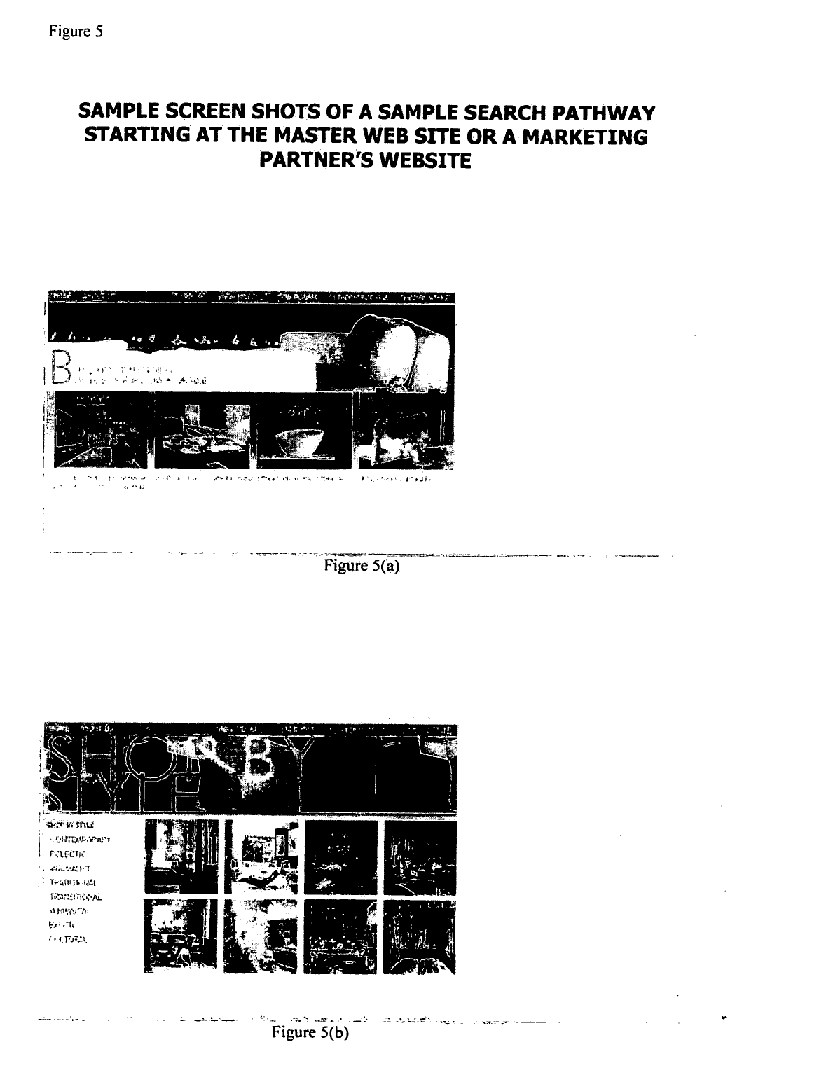

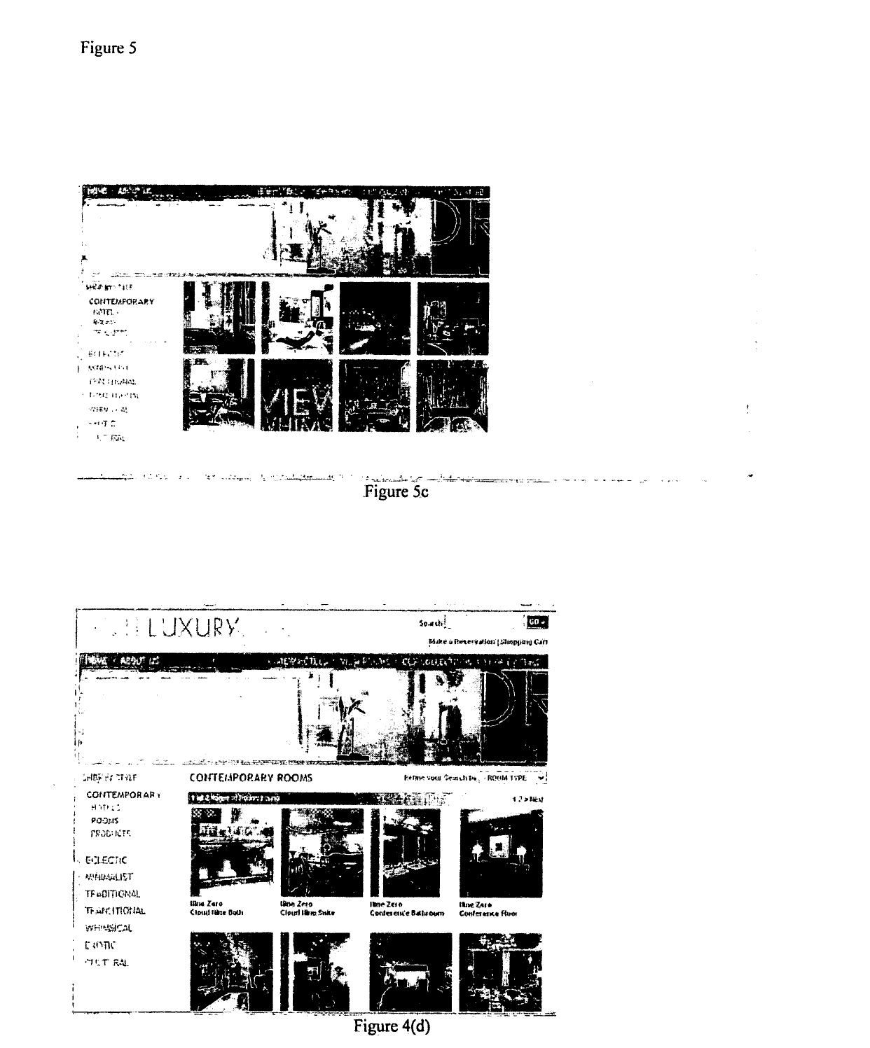

FIG. 4 (a) through (i) illustrate sample screen shots of what a consumer would see as they went through a sample search pathway at a partner hotel's website in order to make a purchase (these Figures/screen shots represent just a few of the many search pathways and screen shots that user would find when using this system

For example, FIG. 4 (a) Sample Hotel Partner home page screen shot
FIG. 4 (b) Screen shot showing sample shopping home page
FIG. 4 (c) Screen shot showing next page in “search by product”
FIG. 4 (d) Screen shot showing next page of furniture choices
FIG. 4 (e) Screen shot showing next page of chair choices
FIG. 4 (f) Screen shot showing specific chair description page
FIG. 4 (g) Screen shot showing pop up perspectives of chair
FIG. 4 (h) Screen shot showing room shots with the chair
FIG. 4 (i) Screen shot of shopping cart if chair being purchased

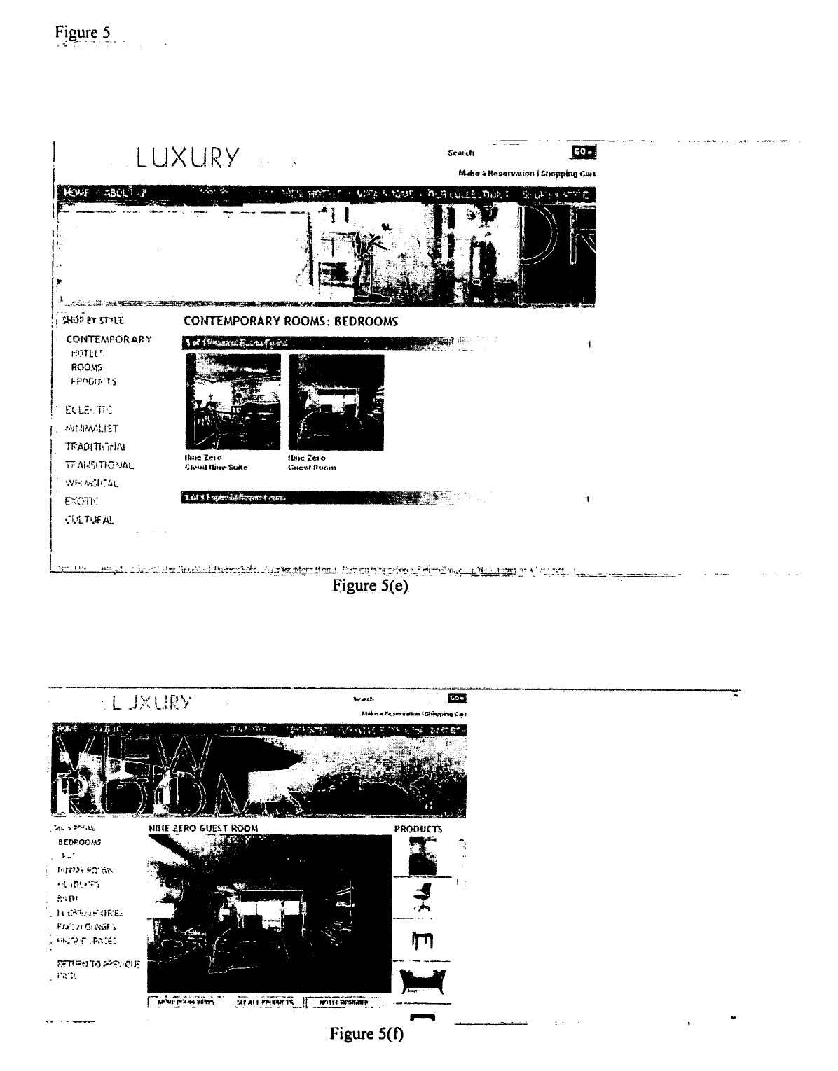

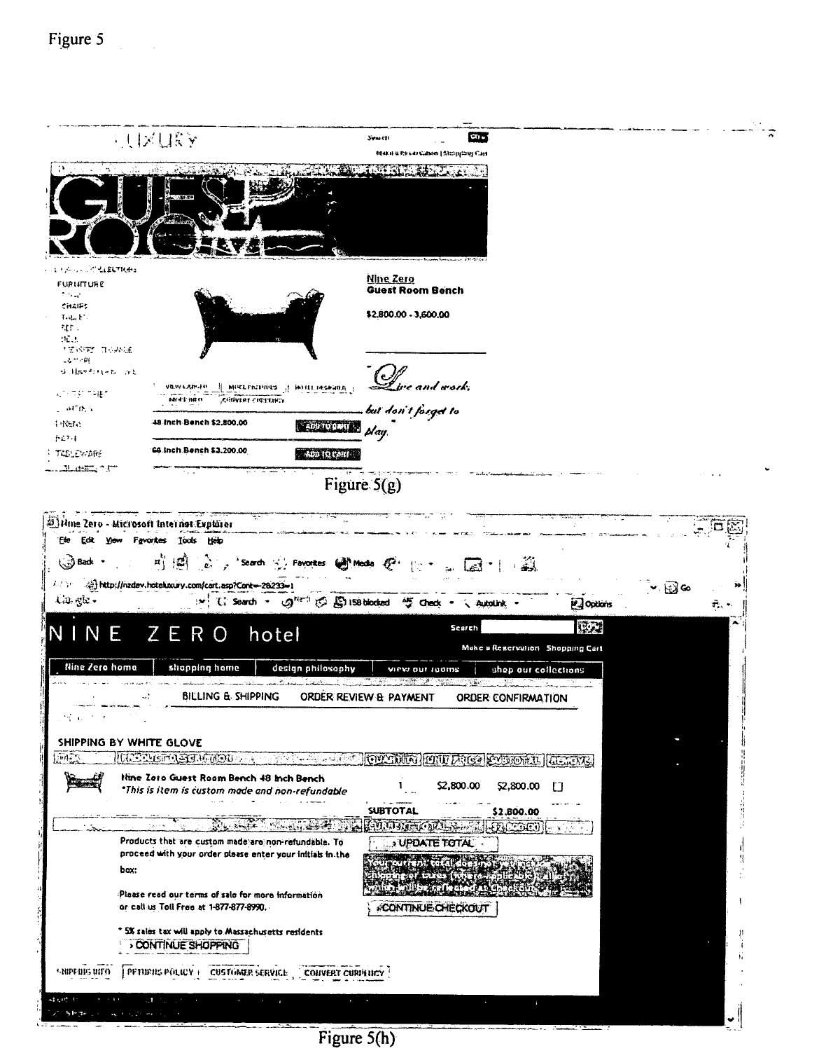

FIG. 5 (a) through (h) illustrate sample screen shots of what a consumer would see as they went through a sample search pathway at the master website. These Figures/screen shots illustrate just a few of the many available search pathways
FIG. 5 (a) Sample Screen shot of Hoteluxury home page
FIG. 5 (b) Sample Screen shot showing “search by style”
FIG. 5 (c) Sample Screen shot of 3 “contemporary” choices
FIG. 5 (d) Sample Screen shot of contemporary “rooms”
FIG. 5(e) Sample Screen shot refining contemporary room search
FIG. 5(f) Sample Screen shot of a contemporary bedroom image
FIG. 5(g) Sample Screen shot of contemporary bedroom product
FIG. 5(h) Sample Screen shot of shopping cart

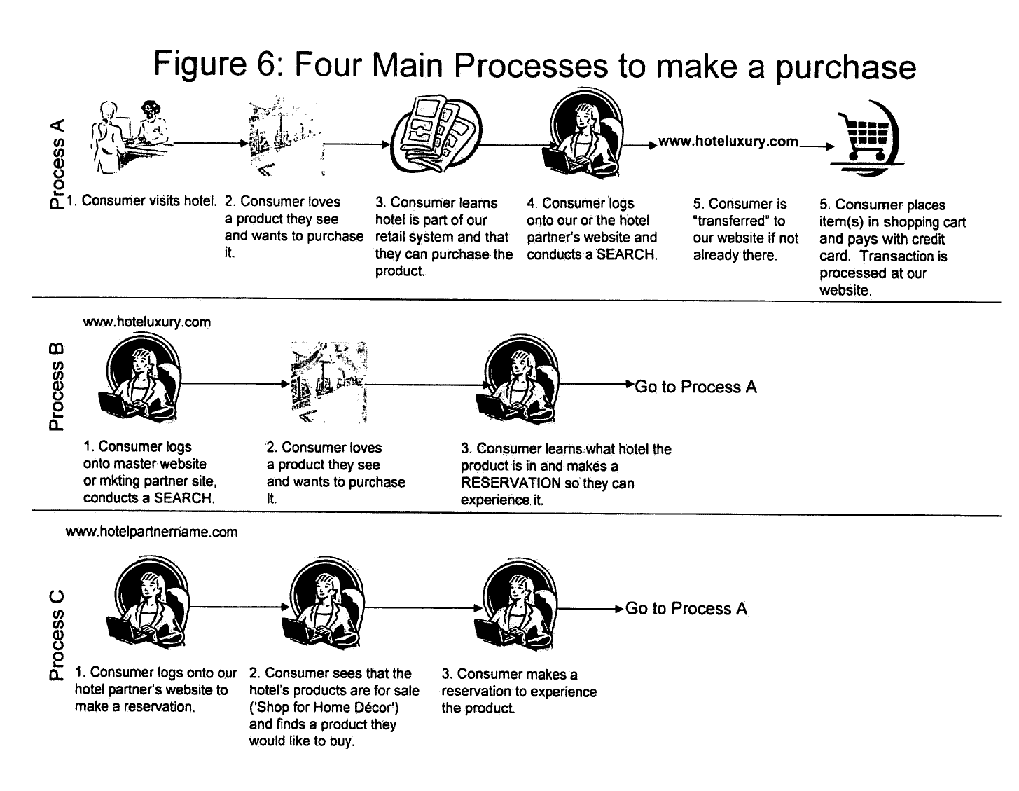

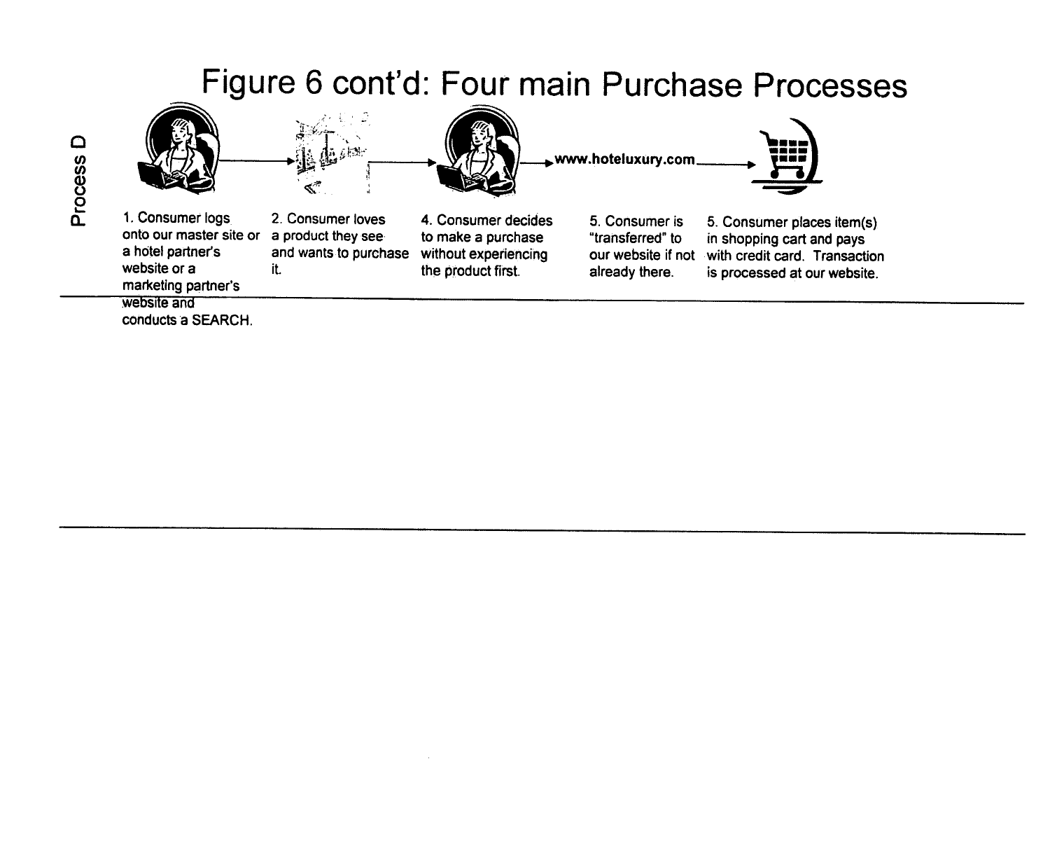

FIG. 6 illustrates the 4 primary processes that a consumer would go through in order to make a purchase using this system.

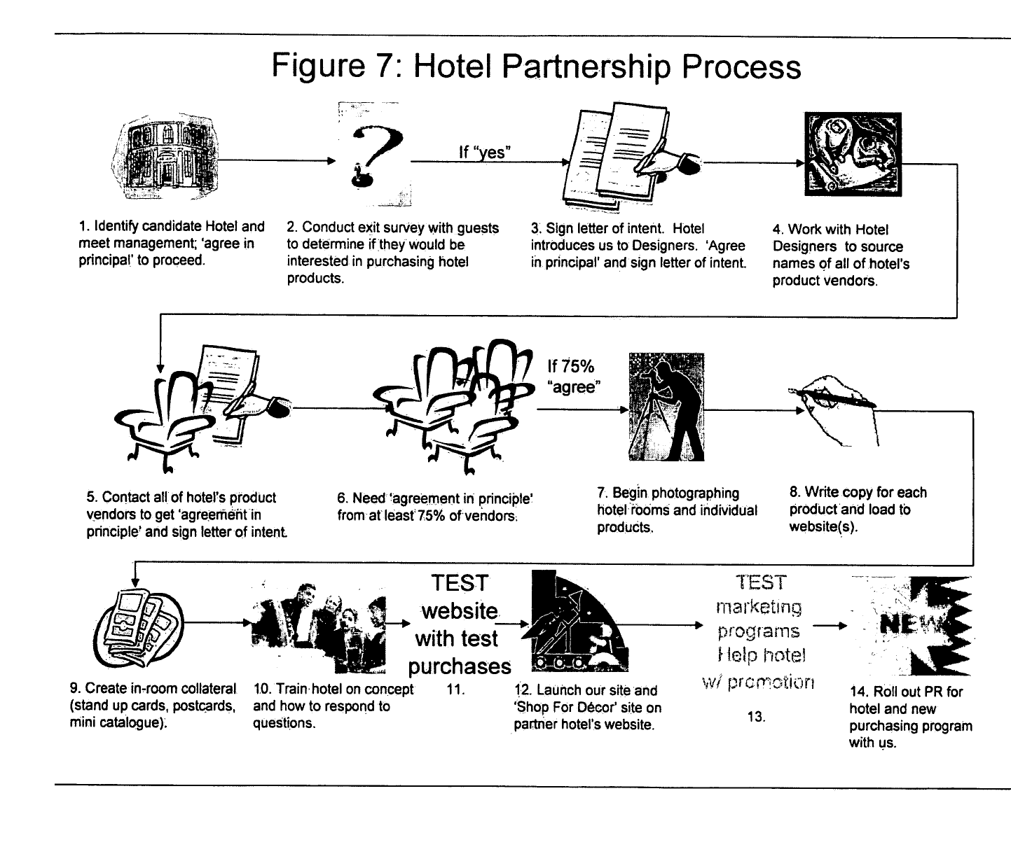

FIG. 7 illustrates the process and steps by which a hotel partner becomes part of the system.

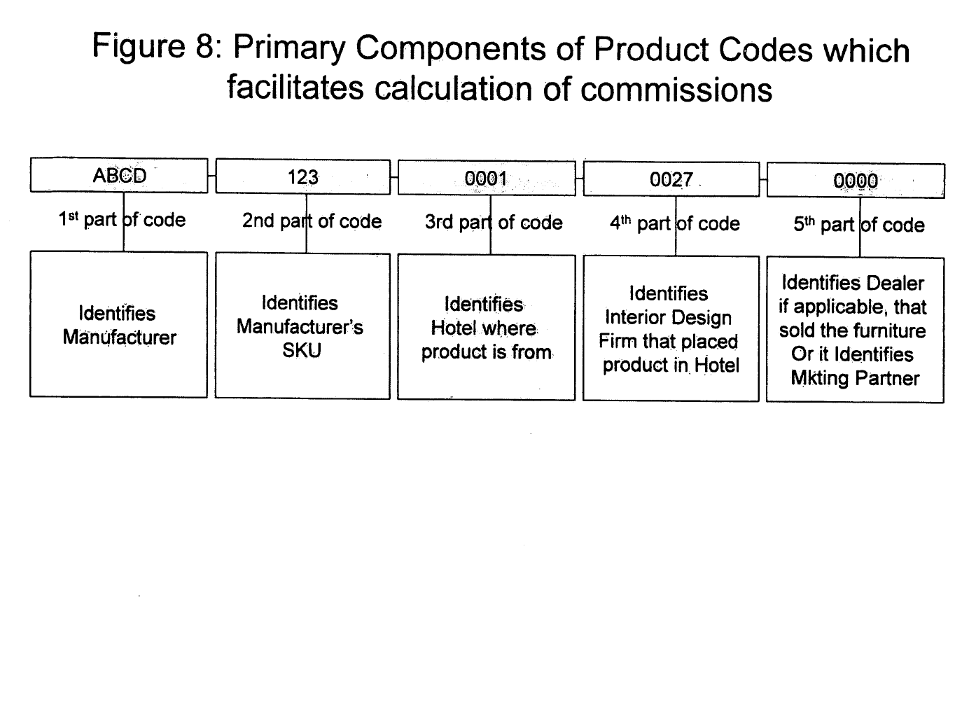

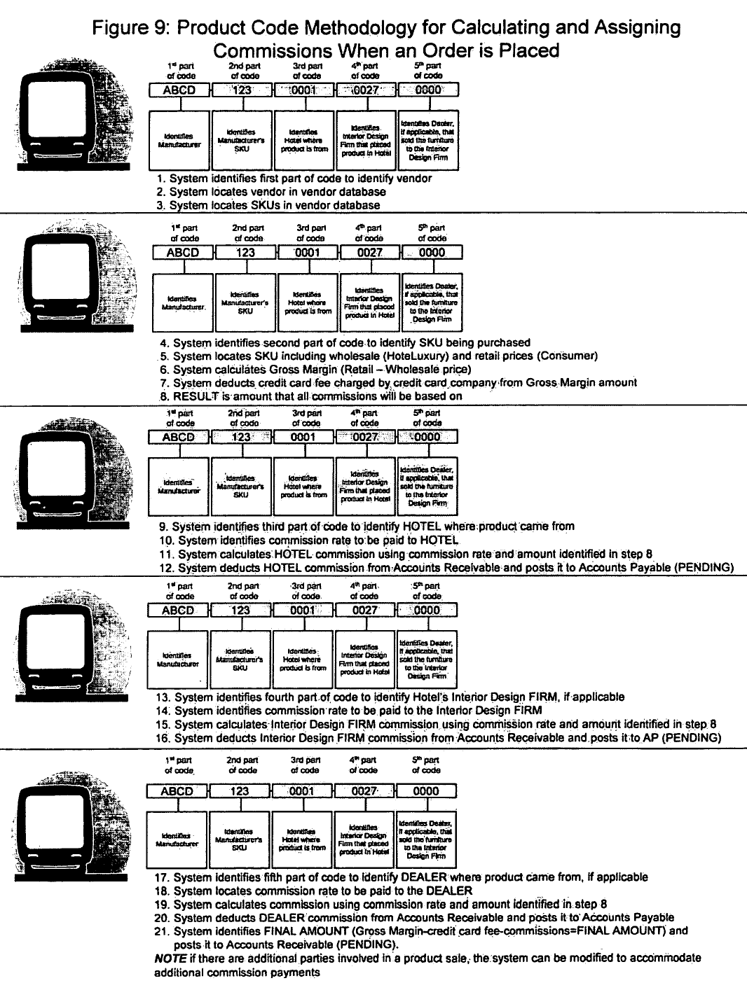

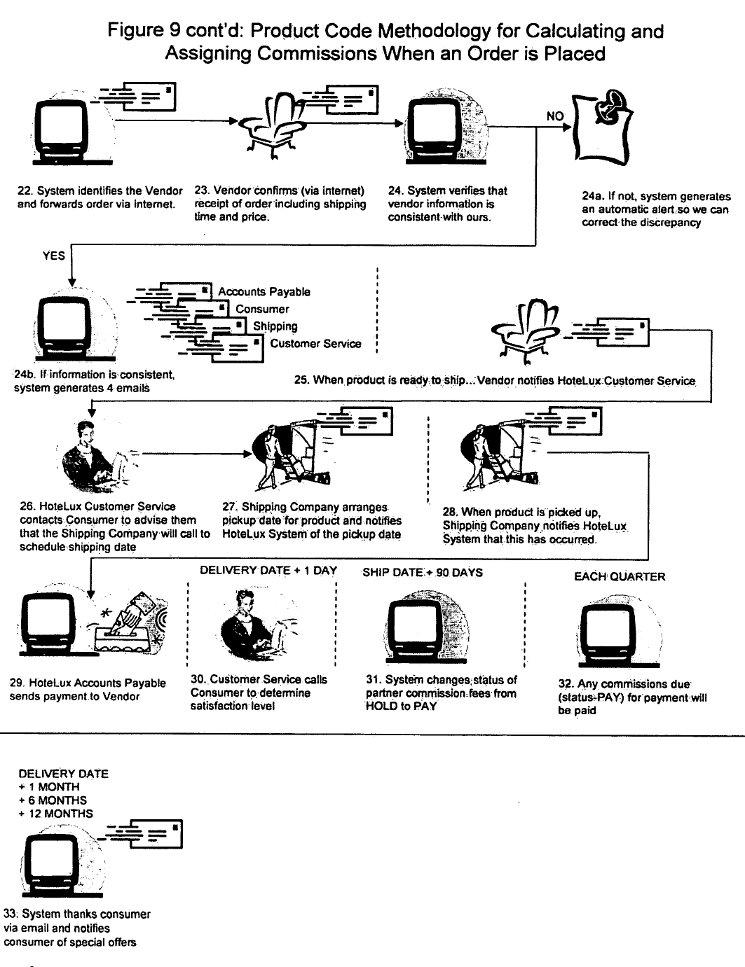

FIG. 8 and FIG. 9 illustrate the manner in which each of the products that are sold on the system have been assigned a multi-part product code so that the system can recognize the different parts of the code and automatically assign sales commissions to the various partners. The system has been designed so that each product could feasibly have unlimited numbers of codes embedded as a subset of every product code however in most cases there will be 5-6 subcomponents to a product code. A typical product code might look like this:

0123. ABC971999. 0001. 0027.000.01 The purpose and importance of each segment of each product code is as follows:

1. The first thing the system does when a product sale is being processed, is to search for the first part of the product code, since this identifies which manufacturer the product has come from. In the above example this part of the code is 0123 and this number might stand for the ACME company in Highpoint N.C.

2. The second part of the product code identifies the specific product or SKU made by that particular manufacture. In the above example this part of the code is ABC971999.

3. Once the system has identified the manufacture and specific SKU, it automatically searches the databases to find the price for which that manufacturer sells us that stock keeping unit (SKU). The system then subtracts this amount from the retail price of the product that is posted on the website (and which is also listed in databases), which results in the system determining the gross margin on that particular product.

4. Once the gross margin has been determined, then the system automatically searches for the third component of the product code which identifies which hotel partner the product came from. In the example here, that part of the code would be “0001” To do this, the system automatically cross references this part of the product code with the data base in which all hotel partner identifier codes are found along with each commission rate that is paid to them. Since all commissions paid out are based on a percentage of gross margin, it is critical that the system automatically determine the gross margin prior to calculating and assigning any commission rates. The commission amount that is assigned to a hotel partner from the product sale is then either manually or electronically “deposited” into that particular hotel partner's “accounts payable” account which will be held there for 90 days until after the product has shipped. Once this wait period is over (which is to account for any potential returns of the product), the commission amount is then moved from being in a “hold” condition to a “pay” condition and a payment is made every quarter to the hotel partners for the amount that has collected in their accounts payable accounts.

5. A similar process occurs for the fourth part of the code, which identifies which interior design firm originally placed that particular product in the partner hotel. In this example, this part of the product code is “0027.” The system then automatically searches the database of interior designers to match the designer code of the sold product with all the identifier codes that are in the designer database to locate the correct design firm that is associated with this particular product sale. Once the designer's code has been confirmed, the system then automatically reads what the commission rate is for that designer and calculates the commission that design firm has “earned” from that product sale. The commission amount that is assigned to this designer is then “deposited” into their accounts payable account and will be held there for 90 days until after the product has shipped. Once this wait period is over, the commission amount is moved from being in a “hold” condition to a “pay” condition and every quarter each designer partner is paid the amounts that has collected in their accounts payable accounts.

6. The fifth part of the product code identifies which dealer, there was one, was involved with making the original sale of this product to the hotel. Alternatively this part of the code might be used to identify the marketing partner, if there is one. In most cases there will not have been a dealer or marketing partner involved, in which case, this part of the product code will read “000” as it does here in the example. If a dealer was involved with this product, the system will automatically search the dealer database to locate the correct dealer that is associated with this particular product sale. Once the dealer's code has been confirmed, the system then automatically reads from the data base, what that dealers commission rate is and calculates the commission that the dealer has “earned” from the product sale. As with all the other partners, all commissions are calculated on the basis of gross profit not the retail price of the product. The commission amount that is assigned to this dealer is then electronically “deposited” into their accounts payable account and will be held there for 90 days until after the product has shipped. Once this wait period is over, the commission amount is moved from being in a “hold” condition to a “pay” condition and every quarter the dealer partners are paid the amounts that have collected in their respective accounts payable accounts.

7. There may also be a sixth part of the product code which may or may not be used. It will be used when the product has been sold using a marketing partner and this marketing partner, like all the aforementioned partners also earns a commissions on each product sold, based on an agreed upon commission rate. The manner is which this code is assigned and operates is the same as the aforementioned codes/partners.

### OPERATING THE SYSTEM

This system is a service, a component of which is the master website that allows users to see very detailed photos of hotel rooms, lobbies, restaurants etc. as well as individual photos of each decorative accessory and piece of furniture that are in each of these rooms

Photographs of all the products that are available for sale from a particular hotel as well as photos of all the rooms where the products can be found will be taken and made accessible to users through the master website as well as through each of the hotel partners web site in a special section designated for home décor shopping. The website will show all the photos from all of the hotel partners while each hotel's website will have a direct link to only those photos from each of their respective hotels. And while all the products for sale can be viewed from each of the partners' website, any and all purchases of these products will be transacted and processed through one centralized location—the master website.

The system includes a web-based ecommerce engine that tracks each sales transaction through the master website using a methodology which provides a series of codes that identify each specific product so that as a product is purchased, an ecommerce engine can automatically determine the gross profit margin from that particular sale and can then automatically determine the correct sales commission to be paid on that product to the correct hotel partner—where the product is found, the correct interior design partner who placed the product in the hotel and the correct dealer (if there is one).

The system has been designed to maintain a database of all hotels, designers, dealers, and marketing partners and assigns each a particular code and specific commission rate to be paid to each of them (that can be changed whenever needed). Thus, whenever a product sale occurs, the system automatically recognizes the part of the product code which identifies which hotel the product came from and the part of the code which identifies which interior designer placed it there (as well as the dealer and/or marketing partner). The assignment of commissions will happen in real time and the system will cumulatively track and calculate the amount of sales commissions that are due to each hotel and interior design partners and after a waiting period (to account for any returns), commission payments will be made to the partners.

The web-based solution will also be the centralized database for collecting and analyzing all the consumer purchases made on a website which will thus provide data that will facilitate cross marketing for partners and for other third parties. Not only will the master website be the location for all sales transactions, it will also be a portal featuring other information on furniture, design and travel and will even allow users to make direct hotel or restaurant reservation at any of the partner hotels.

How the Consumer “Uses” the System

FIG. 6 illustrates the four primary ways that consumers will most frequently use to the system. These four main processes are:

Process A—Consumer stays at the hotel, finds out that the items are for sale, initiates their search at the partner hotel's website and makes a purchase.

Process B—Consumer visits the master website or a marketing partners web site, finds something they would like to purchase, visits the hotel to experience the item(s) and then makes a purchase through either the hotel website, the marketing partner website or the master website.

Process C Consumer initiates search while visiting a partner hotel's website to make a reservation and while doing so, finds that the hotel products are for sale and subsequently a product purchase either before or after experiencing the hotel first.

Process D Consumer visits either a partner hotel's website, the master website or a marketing partner's website—and then buy directly from one of these website without experiencing the hotel or the products first.

Process A: Consumer Starts at a Partner Hotel

1. A consumer is a guest at one of the partner hotels and identifies a product(s) they would like to purchase for their own home. The consumer then visits the hotel's website FIG. 4 (a) illustrates a sample screen shot) where they will find a button that says “shop for home” on the homepage of the hotel's website.

2. The consumer clicks on the “shop for home” button which takes the user to the shopping site that has been created for that specific hotel. FIG. 4 (b) illustrates a sample screen shot of this.

3. The consumer then conducts their search. If they were searching for a piece of home furnishings they have a number of pathways to select from. One such pathway/search is illustrated in FIG. 4 (c) which is a sample screen shot of what the user experiences they have refined their search options.

4. The user is then prompted to make another choice to further refine their search. For example if they were searching for furniture they will be asked to specify what type of furniture and would be provided with a number of word and visual prompts on the next page of the website from which they must select one. FIG. 4 (d) illustrates a sample screen shot of this.

5. The user is then taken to a web page that contains images of all the products that available for sale in the product category that they had selected (e.g. chairs). FIG. 4(e) illustrates a sample screen shot of this.

6. The user then clicks on one of these images which then takes them to the product description page. FIG. 4(f) illustrates a sample screen shot of this.

7. The user is provided with a number of prompts on this new website page from which the user can see the product from different angles/perspectives. FIG. 4(g) illustrates a sample screen shot of this.

8. Another one of the many prompts allows the user to view the product in question is the “In room views” which shows the room(s) where the product is found in at the hotel. FIG. 4 (h) illustrates a sample screen shot of this.

9. If the user chooses to purchase the product, they are prompted by a button on the product information page that takes them to the shopping cart and the transaction is processed.

Process B: Consumer Makes Purchase by Starting at the Master Website or a Marketing Partner's Website

1. As shown in FIG. 5(a), a consumer visits the master website or a marketing partner's website.

2. As shown in FIG. 5(b), the consumer decides to use the “style by search” pathway option.

3. As shown in FIG. 5(c), the consumer selects the style choice they are most interested in (e.g. contemporary) and are then prompted to select either contemporary hotels, contemporary rooms or contemporary products.

4. As shown in FIG. 5(d), if the consumer selected the contemporary “rooms” option, the next webpage will show all of the rooms that the system has identified as “contemporary.

5. As shown in FIG. 5(e), the consumer can then chose to refine their search according to one of many “types” of contemporary rooms (e.g. bedrooms, dining rooms etc).

6. As shown in FIG. 5(f), the user then clicks on the bedroom of their choice where they are taken to a “Room View” which provides a larger view of that room and the individual products that are for sale in that room. Additionally when the user moves their cursor over the room image, the prices of the various items that are for sale in that image pop up on the screen. Also on this “Room View” page, the user will be able to select from many other buttons that either show a larger image of this room, or show them other angles and images of this room, or link them to a page that describes the interior designer who created this room etc.

7. As shown in FIG. 5(g), the user clicks on one of the product images found on the “view room” page and are linked to the product description page for that product.

8. The user may then decide they really do love that particular product but want to experience it before purchasing it so they make a reservation at the hotel to “experience’ the product first hand.

9. The consumer then stays at the hotel, experiences the product and confirms that they want to purchase the product.

10. As shown in FIG. 5(h), the consumer comes back to either the website or the partner's website, finds the product, puts it into their shopping cart to finalize their purchase.

Process C: Consumer Starts at a Partner Hotel's Website to Make a Reservation and While Doing So, Finds That the Hotel Products Are For Sale and Makes Product Purchases Either Before or After Experiencing the Hotel First

1. A consumer visits a partner hotel's “shop for home” section of their website or visits the master Hoteluxury at Home website

2. The consumer does a variety of searches through the website shopping databases and finds a product that they would love to have in their home.

3. The consumer clicks on the product image to see what it looks like in one of the room images and as with all room images, they see which room at the hotel it came from

4. The consumer decides that they really do love that particular product and makes a reservation at the hotel to “experience’ the product first hand.

5. The consumer stays at the hotel, experiences the product and confirms that they want to purchase the product.

6. The consumer comes back to the partner hotel's website or the master Hoteluxuy at Home website, finds the product, and purchases it.

Process D: Consumer Starts at Either a Partner Hotel's Website or the Master Website or a Marketing Partners Website and Then Buy Directly Without Experiencing it First.

1. A consumer visits either the master Hoteluxury at Home website or the “shop for home” section at a partner hotel's website or a marketing partner's website.

2. The consumer does a number of searches for products and find one or more that they like.

3. While the consumer would like to try out the products first hand at the hotel where they are based, they don't have the time or they are confident that they will be satisfied with their purchase without testing the product first hand.

4. The consumer puts the product(s) into their shopping cart and purchases it with their credit card.

As shown in FIG. 9, the following describes how the system processes orders:

1. The consumer is prompted one or more times to initial that they realize the product is non returnable if the product is a custom order.

2. The consumer receives an email confirming their order, is given an order number and may be told how to check the status of their order online.

3. The system identifies the product by its multi-part code and determines the manufacturer, the SKU and the gross margin of the product.

4. The system then checks the database of partners to determine what commissions to pay to the hotel partner, interior design partner and dealer partner (if there was one for that product) and/or the marketing partner. The system calculates these commission amounts using the gross margin that was automatically calculated.

5. The system then determines the appropriate commission amount for each of these partners which is allocated to their respective accounts payable (the commissions move into an active accounts payable 90 days after the product has been shipped in case the product is returned).

6. The system then recognizes the part of the product code that identifies which manufacturer the product is from and pulls their contact information from the manufacturer database.

7. The system then identifies the part of the product code which identifies which SKU from that manufacturer the product actually is and delivers the order for that SKU to the manufacturer via the internet.

8. The manufacturer sends us back a confirmation for the order and confirms the details of the order including the price and shipping time.

9. Once the confirmation has been received, funds are provided to the manufacturer equal to the amount of half the wholesale price of the product to the manufacturer so that the order can begin being processed by them.

10. Once the product is ready to be shipped, notification is provided by the manufacturer at which time the shipping and warehousing agents are contacted with the customer information (address, phone etc).

11. The customer service department then calls the customer to advise them their product is ready for shipping and that a shipping agent will be calling them to arrange a delivery location and date.

12. The shipping and warehousing agent then contact the customer to arrange for a delivery date.

13. The shipping and warehousing agent arrange a date for pickup of the product from the manufacturer and provide the system with the details regarding product pick up and customer delivery.

14. The date the product is to be released by the manufacturer to the shipper is the date that payment is issued for any remaining funds to the manufacturer.

15. The date the product is to be released by the manufacturer to the shipper is the date shipping fees are provided to the shipper.

16. The date after the product is shipped, the customer service department contacts the customer to ensure their satisfaction and to ask other customer service questions.

17. One month after the product has been shipped to the customer, the system sends out a thank you email to the customer along with a promotional offer from the hotel where the product that was purchased had originally come from.

18. Six months after the product has been shipped to the customer, the system sends to each customer, a promotional email offer from the hotel where the product was purchased from.

19. Twelve months after the product has been shipped to the customer the system sends out another promotional offer.

20 Two years after the product has shipped to the customer the system sends out another promotional offer.

In terms of how a user will “operate” within the website, the system has been designed so that the master website, and the shopping sites found on any partner hotel sites or any marketing partner sites will have virtually all the same prompts, buttons, layout and navigational choices so that the networked system can work seamlessly together. Conceptually, the master website is the hub and consolidation of all partner hotel's “shop for décor” sites. Some of these navigational choices include but are not limited to: a) searching for products at a particular partner hotel (which will be listed both alphabetically or by city: b) searching for products at more than one hotel at a time; c) searching for products according to one or more feature at a time such as by product style (contemporary, traditional etc), by room type (bedroom, bathroom etc), by product type (electronics, furniture, lighting etc) by price point ($500-$1,000 etc). Once the first level of search has been done according to one of these particular navigational features, that search can be further refined by any of the remaining search choices not yet used, which will allow the user to narrowly define and find what they are looking for through a hierarchy of increasingly narrower parameters.

Each product search that a user performs on the website will retrieve images of particular products and when the image of this particular product is double clicked a second image will pop up that shows that particular product in the room setting of the hotel where it is found. And discreetly noted below every room image will be the name of the hotel where the room is from. This ability to toggle between a single image of a product and an image of the product in context of a real room where the product is found is a component of the system. It delivers a much more robust understanding of what each product looks in a real setting and also confirms for the user that the product they are interested in purchasing is indeed the same product they may have seen recently in a particular hotel room. Furthermore at any time, the user can double click on the hotel name that is below every room image and they will be immediately taken to the section of the website that shows all of the rooms of that hotel. The system provides users with images that closely approximate the “room experience” and which can “toggle” with all the images of the individual products that are for sale in that room.

Similarly, when a user initiates a search on the website using a specific room or a specific hotel as the primary search criteria, when the resulting room image is served up on the website and the user clicks on it, all the images of the individual products that are available for sale in that room will appear on the screen to the right of the room image (or on a subsequent screen) along with all of the specifications and prices for each of these individual pieces. At this time, the user will also be provided with a prompt that will allow them to “purchase the entire room” with a single “click”. When they click on this “purchase the entire room button” all of the products that are for sale in that room are immediately moved into their shopping cart, shipping costs etc. are calculated after which the user can make payment and check out. This “one click option” will allow those with very little time but a strong interest in duplicating the complete “look” of an entire room with a very easy purchasing process. Alternatively when the individual pieces appear on the screen beside any room image, users can delete those specific pieces they are not interested in purchasing and at any point can move any remaining or all individual pieces to their shopping cart for purchase (or at any time they can move the individual product images as well as the room images to their “design portfolio” for consideration another time).

Process by Which a Hotel Becomes a Partner to Use the System

Referring to FIG. 7, the process and individual steps by which a hotel partner becomes part of the system is shown.
1. conduct (optional) exit survey at hotel with at least 100 guests to determine whether they would be interested in purchasing the hotels furniture and other products
2. if yes, sign contract with hotel who also introduces their designer(s)
3. work with the hotel's designer(s) to source names of all vendors for all furniture and decorative accessories in the hotel
4. contact each vendor to get vendor agreement which confirms their prices and delivery times
5. aim for 75% of all vendors agreement to proceed
6. begin photographing hotel rooms and individual pieces of furniture for sale
7. write copy for each piece of furniture and accessories, load onto master website and hotel “template site”
8. create in-room and in-hotel collateral (stand up cards, postcards, potentially mini catalogue)
9. train hotel staff on concept and how to respond to questions
10. test site with test cases
11. launch master site and hotel's “shop for décor” site—soft launch
12. test marketing programs and help hotel to promote the new e-retail service
13. roll out pr for hotel and its new furniture purchasing service

The timeline for the above is as follows:
1. Agreement in principle with each hotel—1 week (cumulative 1 week)
2. Exit Survey & Analysis of Results—2 weeks (cumulative 3 weeks)
3. Sign hotel contract—1 week (cumulative 4 weeks)
4. Work with designers to source vendor names—2 weeks (cumulative 6 weeks)
5. Contact each manufacturer to agree to work with us 4 weeks (cumulative 10 weeks)
6. Photograph hotel rooms and furniture—2 weeks (cumulative 12 weeks)
7. Write copy for furniture and load onto master website and hotel web template—4 weeks (cumulative 16 weeks)
8. Create in-hotel and in-room collateral—4 weeks (done at the same time as stage—cumulative 16 weeks)
9. Train hotel staff on concept and how to respond to questions—1 week (cumulative 17 weeks)
10 Test site with test cases to get rid of problems—4 weeks (cumulative 21 weeks
11. Soft launch of Master site and hotels template site.

Total timeline: 5½ months to create and launch each hotel partner

With respect to the above mentioned description then, it is to be realized that the optimum and dimensional relationships for the parts of the system/invention, to include variations in size, content, materials, shape, form, function, priority, application, process, partners, products and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described accordingly, all suitable modifications and equivalents may be resorted to, falling within the scope of the invention.

What is claimed is:

1. A method of selecting an item of home furnishings displayed in an accommodation, the method comprising;
accepting from a user an identification associated with one of a plurality of accommodations;
determining the furnishings displayed in the identified one of the plurality of accommodations;
displaying information identifying the displayed furnishings to the user; and
accepting a selection from the user of at least one of the home furnishings.

2. The method of claim 1 further comprising conducting at least a part of a commercial transaction between the user and a supplier of the at least one of the home furnishings.

3. The method of claim 2 further comprising computing a commission for each of a plurality of parties associated with the commercial transaction.

4. The method of claim 1 further comprising accepting from the user an identification of one of a plurality of rooms from the selected one of the plurality of accommodations.

5. The method of claim 1 wherein the plurality of accommodations are hotels.

6. The method of claim 3 wherein each of the furnishings has an associated product code including:
a manufacturer subcode representative of the manufacturer of the furnishing;
a stock keeping (SKU) subcode; and
a partner subcode associated with the accommodation where the furnishing is displayed.

7. The method of claim 6 wherein the product code further includes a designer subcode corresponding to a designer associated with the furnishing, the computing step including determining a commission for the designer.

8. The method of claim 1 wherein accepting the identification of one of the plurality of accommodations and accepting the selection from the user of at least one of the home furnishings is via a communications network.

9. The method of claim 8 wherein the communications network is the Internet.

10. The method of claim 1 wherein the identification is associated with a style of the accessory.

11. The method of claim 1 wherein the identification is associated with a type of the accessory.

12. The method of claim 1 wherein the identification corresponds to a designer associated with the accessory.

13. The method of claim 1 wherein the identification is associated with a location of the accommodation.

14. The method of claim 4 wherein the identification is associated with the one of the plurality of rooms.

15. The method of claim 14 wherein displaying information identifying the displayed furnishings to the user further includes displaying the furnishing in isolation from other furnishings from the one of the plurality of rooms.

16. The method of claim 14 wherein displaying information identifying the displayed furnishings to the user further includes displaying the furnishing with other furnishings from the one of the plurality of rooms.

17. A method for selling a hotel accessory displayed in a hotel, the method comprising:
receiving a sale order from a consumer for the hotel accessory, the hotel accessory having a product code including:
a manufacturer subcode representative of the manufacturer of the hotel accessory;
a stock keeping (SKU) subcode; and
a hotel partner subcode associated with the hotel where the hotel accessory is displayed;
determining a commission for the hotel partner.

18. The method of claim 17 further comprising prior to determining the commission, deducting the cost to the manufacturer of the furniture item from the cost to the consumer.

19. The method of claim 17 further comprising depositing the commission amount to the hotel partner.

20. The method of claim 19 further comprising establishing a wait period before moving the commission from a Hold condition to a Pay condition.

21. The method of claim 17 wherein the product code further includes a designer subcode associated with a designer of the accessory, the determining step including determining a commission for the designer.

22. The method of claim 17 wherein the product code further includes a dealer subcode associated with a dealer of the accessory, the determining step including determining a commission for the dealer.

23. The method of claim 17 wherein the sales order is received over a communications network.

24. The method of claim 17 wherein the hotel accessory is a furniture item.

25. A computer program product residing on a computer readable medium for allowing a user to select an item of home furnishings displayed in an accommodation, the computer program comprises instructions to cause a computer to:
accept from a user an identification of one of a plurality of accommodations;
determine the furnishings displayed in the identified one of the plurality of accommodations;
provide display information identifying the displayed furnishings to the user; and
accept a selection from the user of at least one of the home furnishings.

26. A system for allowing a user to select an item of furnishings displayed in one of a plurality of accommodations, the system comprising:
a memory storing information relating to the furnishings and each of the plurality of accommodations;
a computing device, operably connected to the memory; and conFigured to:
accept from a user an identification of one of the plurality of accommodations;
determine the furnishings displayed in the identified one of the plurality of accommodations;
provide display information identifying the displayed furnishings to the user; and
accept a selection from the user of at least one of the home furnishings; and:
a display for displaying information identifying the displayed furnishings to the user.

27. A system for selling a hotel accessory displayed in a hotel associated with a hotel partner, the system comprising:
a computing device;
a memory operably connected to the computing device, the memory storing a plurality of product codes, each associated with the hotel accessory, the product code including:
a manufacturer subcode representative of the manufacturer of the hotel accessory;
a stock keeping (SKU) subcode; and
a hotel partner subcode associated with the hotel where the hotel accessory is located;
a commission management tool for determining a commission for the hotel partner.
